(19) United States
(12) Patent Application Publication
(10) Pub. No.: US 2020/0077624 A1
(43) Pub. Date: Mar. 12, 2020

(54) Durable and Flexible Pet Toy

(71) Applicants: Travis Kelly Harp, Enumclaw, WA (US); Penny Lou Harp, Enumclaw, WA (US)

(72) Inventors: Travis Kelly Harp, Enumclaw, WA (US); Penny Lou Harp, Enumclaw, WA (US)

(21) Appl. No.: 16/128,458

(22) Filed: Sep. 11, 2018

(51) Int. Cl. A01K 15/02; C08L 11/00; C08L 23/16

(52) U.S. Cl. CPC A01K 15/026; C08L 2201/08; C08L 23/16; C08L 11/00

(57) ABSTRACT

A durable and flexible pet toy may be made from special combinations of elastomeric materials, by selecting those materials useful for making strong, long-lasting flexible toys with rubberlike quality. The quality of a durable and flexible pet toy is in that it remains in its original form, for the most part, even after strong chewing and strong pulling by pets. It may also be long-lasting entertainment for pets, due to the resilient quality. This toy may withstand constant mechanical force imposed by strong pets, such as dogs. Embodiments of this toy may come in various colors, shapes and sizes, flavors and different textures. Additionally, different objects may be attached to the durable and flexible pet toy. For example, a rope or a bell, or another durable and flexible pet toy.

### FIELD

This disclosure generally relates to a durable and flexible pet toy.

### BACKGROUND

Pet toys are intended to keep a pet occupied for hours at a time. Some pets need pet toys for chewing for when they are teething and after they mature. Various pet toys are made from different materials and come in different shapes and sizes. Some pet toys are made from materials like rope, plush or plastic, for example. Pet toys made from these materials do not typically stand up to strong chewing or strong pulling. These pet toys tear or lose their original shape after undergoing the tension of strong chewing or strong pulling. Within a relatively short period of time, pets tend to destroy pet toys made from materials that are not capable of withstanding strong pulling or strong chewing. This tendency of fragility in pet toys leads to increased costs of maintaining pet toys around for pets to enjoy, due to the cost of replacing pet toys.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

The instant application discloses, among other things, a durable and flexible pet toy, developed from materials that may be useful for withstanding rugged playing by pets. A durable and flexible pet toy may be made from a blend of materials like amorphous elastomers.

Durable elastomeric materials are materials having a blend of fibers, such as rubber. A durable and flexible pet toy may be made from a blend of materials that produce a tough elastomeric flexible material having a rubberlike quality. An example of an elastomeric type of material which may be selected for blending to produce a durable and flexible pet toy is chloroprene elastomers; one instance of such an elastomer type is polychloroprene. Materials like polychloroprene may be used to produce an elastomer material suitable to produce a durable and flexible pet toy. A durable and flexible pet toy may be made using a high viscosity type of elastomer, such as ethylene propylene diene monomer, which exhibits elements of viscoelastic properties. Durable and flexible pet toys may be made from other materials designated to be elastomers, elastomeric, or rubbery state.

The elastomer blending process may be completed with proper reinforcing materials, such as chlorine, carbon blacks and or precipitated silicas, to produce a durable and flexible pet toy which may demonstrate high tensile strength. A high tensile strength may be the result of elastomers having weak interchain or intermolecular reactions, which means they crystalize temporarily when stretched, yet revert back to their original amorphous elastomeric state and dimensions when the stretching force is removed. A variety of particulate fillers may be used to enhance the physical properties of the materials used to make a durable and flexible pet toy. Such strength properties are possible with proper fillers. Embodiments of a durable and flexible pet toy may be made from materials blended to produce durable properties, such as ozone, oil, water, weather, cracking, and heat resistance, and in addition may have high tensile and tear strength; materials may also be selected to produce inflatable and elastic properties.

Ethylene propylene diene monomer rubber may be a typical elastomer made from a blend of materials suitable for producing embodiments of a durable and flexible pet toy. While the elastomer ethylene propylene diene monomer rubber material is solid and dense, it is also very pliable and flexible. Ethylene propylene diene monomer rubber may be a typical elastomer used for making various embodiments of the durable and flexible pet toy.

Ethylene propylene diene monomer rubber material may be molded to make durable and flexible pet toys in various shapes and sizes, for instance the shape of a dog chew toy. Some dog chew toy shapes that may embody a durable and flexible pet toy are ball, ring, loop, or a rounded bone shape. An embodiment of a durable and flexible pet toy may be a long-rounded shape, such as a long rounded hot dog shaped toy with spherical shaped ends. The spherical shaped ends may have grooves for 0 rings in their circumferences, and O rings positioned in the grooves to form ridges. These ridges may prevent the durable and flexible pet toy from slipping out of a pet's mouth. The grooves and O rings are optional. In another embodiment, a durable and flexible pet toy may be made to have airtight walls made of a single integral piece of elastomeric material. Importantly, the shape of a durable and flexible pet toy is not essential.

### BRIEF DESCRIPTION OF THE DRAWINGS

FIG. 1 illustrates one aspect of a durable and flexible pet toy.

FIG. 2 illustrates a block diagram of one top view aspect of one embodiment of a durable and flexible pet toy.

FIG. 3 illustrates a block diagram of one top view aspect of one embodiment of a durable and flexible pet toy.

FIG. 4 illustrates a block diagram of one cross-sectional view aspect of one embodiment of a durable and flexible pet toy.

### DETAILED DESCRIPTION

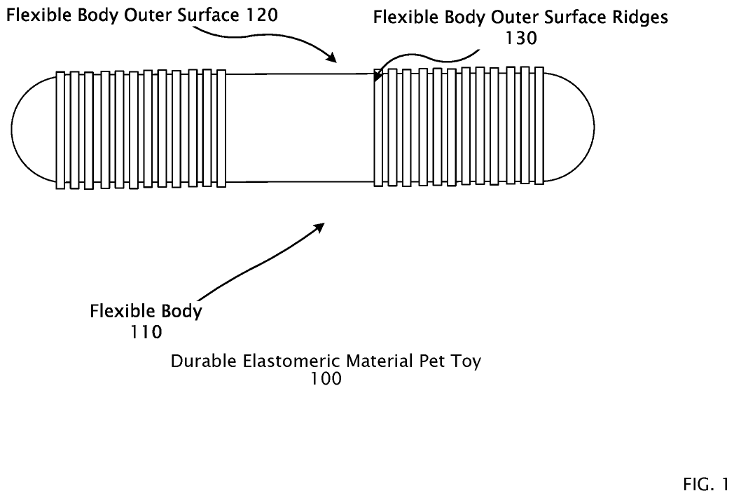

FIG. 1 illustrates one aspect of a Durable and Flexible Pet Toy 100, according to one embodiment. Durable and Flexible Pet Toy 100 may be developed from materials that are useful for withstanding rugged playing by pets. Durable and Flexible Pet Toy 100 may be made from amorphous elastomers. Durable and Flexible Pet Toy 100 may show temporary crystallization when a mechanical force stretches it to a high extension, but will retract to its original dimensions when the force is removed. When Durable and Flexible Pet Toy 100 is extended or stretched, individual long-chain polymer molecules are partially uncoiled, and will coil up again when the force that is causing the stretching is removed.

Durable and Flexible Pet Toy 100 may be made from durable elastomeric materials having a blend of fibers that include natural rubber or other materials having a rubberlike quality. An example of an elastomeric type of materials which may be selected for blending to produce a Durable and Flexible Pet Toy 100 is the chloroprene, which is a category of elastomers; one instance of such an elastomer is polychloroprene. Materials like polychloroprene may be used to make an embodiment of Durable and Flexible Pet Toy 100. Another suitable material may be a high viscosity type of elastomer, such as ethylene propylene diene monomer, which exhibits elements the desired viscoelastic properties. These materials exhibit the desired property of being capable of reverting back to most of Durable and Flexible Pet Toy 100's original dimensions after undergoing extension or compression. Moreover these materials may be combined to produce embodiments of Durable and Flexible Pet Toy which have the capability of floating in water or another liquid. Durable and Flexible Pet Toy 100 may be made from other materials designated to be elastomers, elastomeric, or rubbery state.

Once elastomer blending is completed, using proper reinforcing materials, such as chlorine, carbon blacks and or precipitated silicas, the resulting Durable and Flexible Pet Toy 100 may demonstrate a high tensile strength. A variety of particulate fillers may be used to enhance the physical properties of the materials used to make Durable and Flexible Pet Toy 100. For example, reinforcing carbon blacks and precipitated silicas are reinforcing fillers, used to reinforce abrasion resistance, tear strength, and tensile strength. Adding one or more of these fillers to the blend of materials used to make Durable and Flexible Pet Toy 100 may extend the recovery life of the toy, especially where the imposition of mechanical forces may be regular, such as the tension and stretching force caused during repeated aggressive pulling by pets. Durable and Flexible Pet Toy 100 may be produced to exhibit an elongating of at least 300 percent and a tensile strength capable of withstanding at least 13 p.s.i., for instance. Such strength properties may be possible with the selection of proper fillers.

Durable and Flexible Pet Toy 100 may be made from elastomeric materials blended to produce Durable and Flexible Pet Toy 100 with enhanced durable properties, such as ozone, oil, water, weather, cracking, and heat resistance. Additionally, a combination of materials may be incorporated to produce Durable and Flexible Pet Toy 100 with flexible properties, such as high tensile and tear strength, and a high elongation percentage. For example, elastomeric materials useful for their inflatable and elastic properties are suitable for making Durable and Flexible Pet Toy 100.

Ethylene propylene diene monomer rubber may be a typical elastomer made from a blend of materials suitable for producing Durable and Flexible Pet Toy 100. Ethylene propylene diene monomer rubber has good resistance to anti-freeze, synthetic detergents, acetone, boric acid, ethanol, formaldehyde, mercury, potassium sulfate, silver nitrate, saccharin, and even steam. It also exhibits great resistance to a wide temperature range, as it may be capable of enduring temperatures as low as −40° F. and as high as 212° F. While the elastomer ethylene propylene diene monomer rubber material is solid and dense, it also has a good degree of pliability and flexibility. The elastomer ethylene propylene diene monomer rubber material may also have a minimum tensile strength of 725 PSI and an elongation that ranges over 300 percent. Given these qualities, ethylene propylene diene monomer rubber may be a typical elastomer used for making various embodiments of Durable and Flexible Pet Toy 100. Durable and Flexible Pet Toy 100 may have a Flexible Body Outer Surface 120, which may be a surface of airtight walls made of a single integral piece of elastomeric material exhibiting rubbery behavior.

As previously mentioned, Durable and Flexible Pet Toy 100 may be made out of the elastomer ethylene propylene diene monomer rubber material, which may be molded and used to make embodiments of Durable and Flexible Pet Toy 100 in various shapes and sizes. Some embodiments may include a ball, a ring, a loop, or a rounded bone shape. Another embodiment may be a long-rounded cylindrical shape with spherical shaped ends, exhibited by Flexible Body 110. The spherical shaped ends may have grooves for O rings in their circumferences, and O rings positioned in the grooves may form Flexible Body Outer Surface Ridges 130. These ridges may prevent Durable and Flexible Pet Toy 100 from slipping out of a pet's mouth. The grooves and O rings are optional.

As described above, Durable and Flexible Pet Toy 100 may be embodied in various shapes and sizes—for any shape. For instance, Flexible Body 110, in the shape of a rounded cylinder with spherical shaped ends, may be embodied having varying diameters. The shape of Durable and Flexible Pet Toy 100 is not essential.

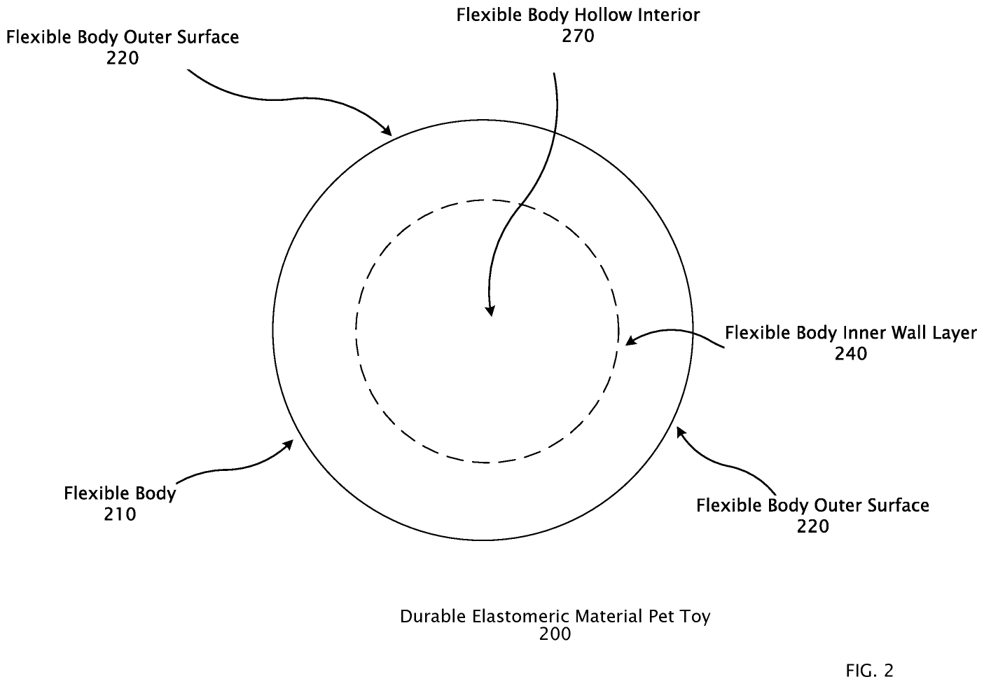

FIG. 2 illustrates a block diagram of one open cross-sectional top view aspect of a Durable and Flexible Pet Toy 200, according to one embodiment. As previously described, Durable and Flexible Pet Toy 200 may be developed from materials that are useful for withstanding long-lasting rugged playing by pets. Durable and Flexible Pet Toy 200 may have a Flexible Body Outer Surface 220 and a Flexible Body Inner Wall Layer 240, formed from airtight walls made of a single integral piece of elastomeric material exhibiting rubbery behavior. Flexible Body Inner Wall Layer 240 may have varying thickness. Flexible Body 210, may be a rounded cylinder with spherical shaped ends, having varying diameters. The size and shape of Durable and Flexible Pet Toy 200 is not essential. Durable and Flexible Pet Toy 200 may have a hollow interior, exhibited here by Flexible Body Hollow Interior 270. This hollow interior may enable Durable and Flexible Pet Toy 200 to float in water or other liquids. Elastomeric materials used to make Flexible Body 210 may be selected to due to their inflatable and elastic properties.

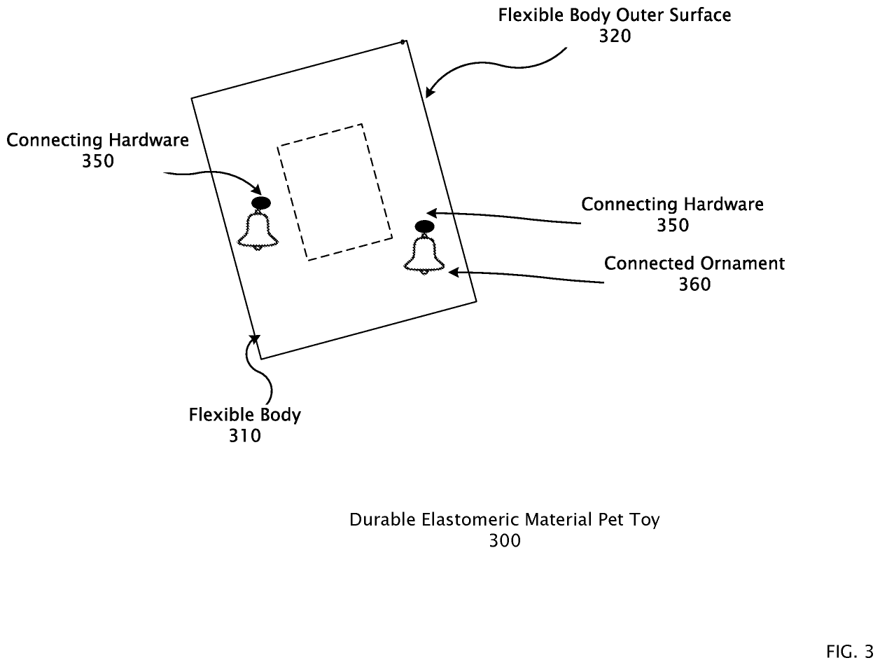

FIG. 3 illustrates a block diagram of one top view aspect of a Durable and Flexible Pet Toy 300, according to one embodiment. Flexible Body Outer Surface 320 and a Flexible Body Inner Wall Layer 340 may be formed from airtight walls made of a single integral piece of elastomeric material exhibiting rubbery behavior. Flexible Body 310, may be a rounded rectangular shape having varying dimensions. Dimension, size, body structure, and shape of Durable and Flexible Pet Toy 300 is not essential. Durable and Flexible Pet Toy 300 may have Connecting Hardware 350, which may be a connector head adapted to receive a type of connection to affix a Connected Ornament 360. Connecting Hardware 350 may be a loop with twisted rope, hook and loop fastener, or a snap fastener, for example. The Connected Ornament 360 may be a bell, a flash light, a tracking device, or a pet treat, for example.

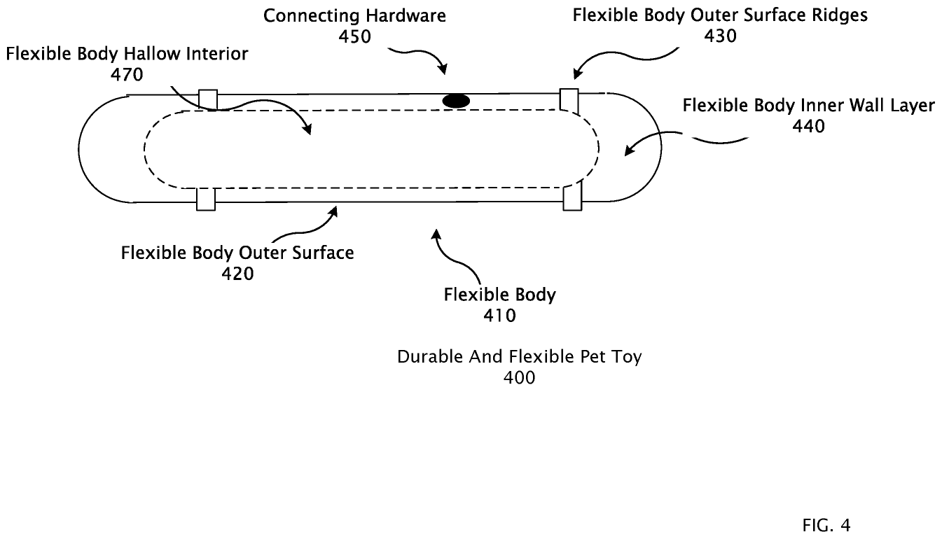

FIG. 4 illustrates a block diagram of one cross-sectional view aspect of a Durable and Flexible Pet Toy 400, according to one embodiment. Flexible Body 410 may have a thickened Flexible Body Inner Wall Layer 440, having a varying circumferentially placed and spaced Flexible Body Outer Surface Ridges 430. Connecting Hardware 450 may be assembled and placed in various places on Flexible Body Outer Surface 420. Flexible Body Inner Wall Layer 440 may have airtight walls made in a variety of thicknesses, including any thickness in the range of 1/16″ to 2″. Durable and Flexible Pet Toy 400 may have a hollow interior, exhibited here by Flexible Body Hollow Interior 770, which may have varying dimensions.

A flavor or scent, or colors, may be added to Durable and Flexible Pet Toy 400 to materials that make up Durable and Flexible Pet Toy 400 for the purpose of appealing to pets.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention. Since many embodiments of the invention can be made without departing from the spirit and scope of the invention, the invention resides in the claims hereinafter appended.

1. A durable and flexible pet toy, comprising a hollow flexible body, made from elastomeric materials having elongate percentage of at least 300 percent.

2. The durable and flexible pet toy of claim 1, wherein said flexible body is constructed of amorphous elastomeric material.

3. The durable and flexible pet toy of claim 2, wherein said amorphous elastomeric material has a minimum tensile strength of 13 p.s.i.

4. The durable and flexible pet toy of claim 1, wherein said flexible body is constructed from a combination of materials consisting of least one amorphous elastomer.

5. The durable and flexible pet toy of claim 1, wherein said flexible body is resistant to oxygen, heat, water, ozone, and steam.

6. The durable and flexible body of claim 1, wherein said flexible body further comprises a viscoelastic outer surface.

7. The durable and flexible pet toy of claim 6, wherein said viscoelastic outer surface has walls constructed essentially out of a single integral piece of elastomeric material.
